(19) United States
(12) Patent Application Publication
(10) Pub. No.: US 2015/0128029 A1
(43) Pub. Date: May 7, 2015

(54) METHOD AND APPARATUS FOR RENDERING DATA OF WEB APPLICATION AND RECORDING MEDIUM THEREOF

(71) Applicant: Samsung Electronics Co., Ltd., Suwon-si (KR)

(72) Inventors: Sei-kwon KIM, Daejeon (KR); Ho-sung KIM, Bucheon-si (KR); Eun NAMGUNG, Hwaseong-si (KR); Zhang-hoon OH, Yongin-si (KR); Jong-ho LEE, Seoul (KR); Kang-yong PARK, Suwon-si (KR); Ji-hoon O, Suwon-si (KR); Hyung-kang HEO, Suwon-si (KR); Seung-yeol HYUN, Seoul (KR)

(21) Appl. No.: 14/534,500

(22) Filed: Nov. 6, 2014

(30) Foreign Application Priority Data
Nov. 6, 2013 (KR) 10-2013-0134361

(51) Int. Cl. G06F 17/22

(52) U.S. Cl. CPC G06F 17/227; G06F 17/2247; G06F 17/2252
USPC 715/236; 715/234; 715/239

(57) ABSTRACT

A method of rendering data of an application is provided. A source code of the application is acquired to extract attribute information of data displayed on an execution screen of the application from the acquired source code and render data based on the extracted attribute information. Therefore, a speed and efficiency for rendering data are improved.

### CROSS-REFERENCE TO RELATED APPLICATION(S)

This application claims the benefit under 35 U.S.C. §119(a) of a Korean patent application filed on Nov. 6, 2013 in the Korean Intellectual Property Office and assigned Serial number 10-2013-0134361, the entire disclosure of which is hereby incorporated by reference.

### TECHNICAL FIELD

The present disclosure relates to a method and apparatus for rendering data of a web application and a recording medium thereof.

### BACKGROUND

As smartphones have increased in popularity, various types of applications have been developed. In particular, among the various types of applications, demands of users for dynamic applications such as games have increased, and thus the dynamic applications have been increasingly developed.

The dynamic applications demand high frame rates. Therefore, a rendering speed of data displayed on a screen when executing an application is one of major factors that are considered when developing the application. The rendering speed may also be affected by a type and a performance of a device in which the application is executed.

In a case of developed applications, a rendering method determined in a development step may not be changed. Therefore, in a case of an application that is developed to be optimized for a particular device, if specifications of the particular device are changed or the application is used in another type of device, a performance of the application is deteriorated.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for adaptively changing a rendering method according to an application execution environment if rendering data displayed on a screen when executing an application to optimally maintain a rendering speed in order to improve a performance of the application, and a recording medium thereof.

Additional aspects will be set forth in part in the description which follows and, in part, will be apparent from the description, or may be learned by practice of the presented various embodiments.

In accordance with an aspect of the present disclosure, a method of rendering graphic data is provided. The method includes acquiring first space information of at least one object indicated by graphic data of a first frame, determining sampling modes of a plurality of pixels included in the first frame based on the graphic data of the first frame, and rendering graphic data of a second frame based on the first space information and the sampling modes of the plurality of pixels included in the first frame.

The method may further include rendering graphic data of a current frame based on space information of at least one object indicated by graphic data of a previous frame and sampling modes of a plurality of pixels included in the previous frame.

In accordance with another aspect of the present disclosure, a method of rendering data of an application is provided. The method includes acquiring a source code of the application, extracting attribute information of data displayed on an execution screen of the application from the acquired source code, and determining a method of rendering the data based on the extracted attribute information.

The determining of the method may include changing the source code of the application based on the determined method.

The changing of the source code of the application may include if an acquired first source code does not match with a second source code corresponding to the determined method, changing the first source code into the second source code.

The extracting of the attribute information of the data may include parsing the acquired source code, and extracting the attribute information of the data from the parsed source code.

The attribute information of the data may include at least one of information about a shape, a shadow, a color, a position, a material, and a size of an object included in the data.

The method of rendering the data may include one of web graphic library (WebGL) rendering, cascading style sheet (CSS) rendering, and canvas rendering.

The method may further include reconfiguring the application based on the changed source code.

The method may include selecting a rendering method corresponding to the changed source code, and rendering the data by using the selected rendering method.

The method may further include calculating the number of data that is rendered for a preset time, and re-determining the method of rendering the data based on the calculated number of data.

If the calculated number of data is lower than a threshold value, the method of rendering the data may be re-determined.

In accordance with another aspect of the present disclosure, an apparatus for rendering data of an application is provided. The apparatus includes an input/output (I/O) unit which acquires a source code of the application, and a controller which extracts attribute information of data displayed on an execution screen of the application from the acquired source code and determines a method of rendering the data based on the extracted attribute information.

The controller may change the source code of the application based on the determined method.

If an acquired first source code does not match with a second source code corresponding to the determined method, the controller may change the first source code into the second source code.

The controller may parse the acquired source code and extract the attribute information of the data from the parsed source code.

The attribute information of the data may include at least one of information about a shape, a shadow, a color, a position, a material, and a size of an object included in the data.

The method of rendering the data may include one of WebGL rendering, CSS rendering, and canvas rendering.

The apparatus may further include a packaging unit which reconfigures the application based on the changed source code.

The apparatus may further include a renderer which renders the data by using a rendering method that is selected by the controller based on the changed source code.

The apparatus may further include a calculator which calculates the number of data that is rendered for a preset time. The controller may re-determine the method of rendering the data based on the calculated number of data.

If the calculated number of data is lower than a threshold value, the controller may re-determine the method of rendering the data.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a system for rendering data of an application according to an embodiment of the present disclosure;

FIG. 2 is a flowchart illustrating a method of rendering data according to an embodiment of the present disclosure;

FIG. 3 is a flowchart illustrating a method of rendering graphic data by using an apparatus for rendering graphic data in detail according to an embodiment of the present disclosure;

FIG. 4 is a block diagram illustrating an apparatus for rendering data according to an embodiment of the present disclosure;

FIG. 5 is a flowchart illustrating a method of reconfiguring an application based on a source code of a reconfigured application by using an apparatus for rendering data according to an embodiment of the present disclosure;

FIG. 6 is a block diagram illustrating an apparatus for rendering data according to another embodiment of the present disclosure;

FIG. 7 is a flowchart illustrating a method of rendering based on a source code of reconfigured application by using an apparatus for rendering data according to an embodiment of the present disclosure;

FIG. 8 is a block diagram illustrating an apparatus for rendering graphic data according to an embodiment of the present disclosure;

FIG. 9 is a flowchart illustrating a method of re-determining a method of rendering data when executing an application by using an apparatus for rendering data according to an embodiment of the present disclosure; and

FIG. 10 is a block diagram illustrating an apparatus for rendering graphic data according to another embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood that when an element, such as a layer, a region, or a substrate, is referred to as being “on,” “connected to” or “coupled to” another element, it may be directly on, electrically connected or coupled to the other element or intervening elements may be present. In contrast, when an element is referred to as being “directly on,” “directly connected to” or “directly coupled to” another element or layer, there are no intervening elements or layers present. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The present disclosure will now be described in detail with reference to the attached drawings.

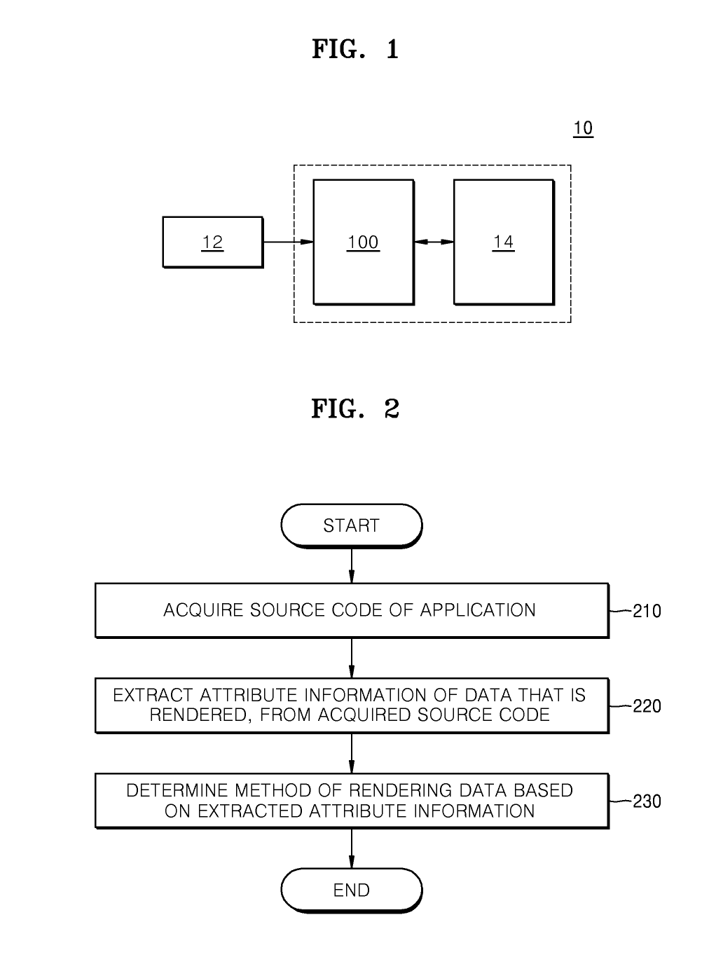

FIG. 1 is a view illustrating a system 10 for rendering data of application according to an embodiment of the present disclosure.

The system 10 of FIG. 1 includes elements related to the present embodiment. Therefore, the system 10 may further include other types of general-purpose elements besides the elements of FIG. 1.

Referring to FIG. 1, the system 10 may include a device 14 that executes the application and an apparatus 100 that renders data of the application.

The device 14 may include a device that performs a particular job in the application to display the performance result on a display unit such as a screen or the like. For example, the device 14 may include a computer, a tablet personal computer (PC), a smartphone, a smart television (TV), or the like but is not limited thereto.

In the whole specification, the term ‘application’ refers to a set of a series of computer programs that are invented to perform the particular job. The application described herein may be various. For example, the application may be a game application, a performance application, a video play application, a map application, or the like but is not limited thereto.

An application 12 described herein may include a web application that is application software that may be used in a web browser through the Internet or Intranet. For convenience of description, various embodiments of the present disclosure will be described based on the web application. Also, data described herein may include image data, script data, or the like that may be displayed on a screen.

The apparatus 100 that renders the data of the application 12 may receive information about the application 12. The information about the application 12 may include attribute information about data that is rendered when executing the application 12. For example, the information about the application 12 may include a source code of the application 12. However, the source code is only an embodiment of the information about the application 12 and is not limited thereto.

The apparatus 100 that renders the data of the application 12 may determine a method of rendering data based on at least one of attribute information about the data and performance information of the device 14. This will be described in detail further below with reference to FIGS. 2 through 4.

FIG. 2 is a flowchart illustrating a method of rendering the data of the application 12 according to an embodiment of the present disclosure.

In operation 210, the apparatus 100 that renders the data of the application 12 acquires a source code of the application 12.

The apparatus 100 according to the present embodiment may acquire the source code of the application 12 from an external device. According to another embodiment, the apparatus 100 may acquire the source code from an application package that is stored in the apparatus 100 or is acquired from the external device.

The application package may be data into which the source code of the application 12, a file for executing the application 12, etc. are compressed. The apparatus 100 decompress the application package to extract the source code from the application package.

In operation 220, the apparatus 100 extracts attribute information of data, which is rendered, from the acquired source code. Here, the attribute information of the data may include at least one of all attributes that may be processed by a graphic processing unit (GPU), i.e., at least one of a shape, a shadow, a position, a material, a size, etc. of an object that are included in the data. Also, the object may be all types of graphic elements that constitute the data. For example, the object may be a thing or a background included in an image displayed on a screen. The object may also include a programming element that constitutes the data. For example, the object may be a code that constitutes the data.

The apparatus 100 according to the present embodiment may parse the acquired source code. The apparatus 100 may extract the attribute information of the data from the parsed source code.

In operation 230, the apparatus 100 determines a method of rendering the data based on the extracted attribute information. The method of rendering the data according to the present embodiment may include web graphic library (WebGL) rendering, cascading style sheet (CSS) rendering, and canvas rendering.

The apparatus 100 according to the present embodiment may determine the method of rendering the data based on a size of the extracted attribute information. For example, there exist data A of which attribute information has a size of 100 bytes and data b of which attribute information has a size of 50 bytes. The apparatus 100 may determine CSS rendering as a method of rendering the data B of which attribute information has a relatively small size. In general, the CSS rendering may be used to render data of which attribute information has a smaller size. In general, if an image displayed on a screen is not complicated, a size of attribute information of the data may be small.

The apparatus 100 may determine one of WebGL rendering and canvas rendering as a method of rendering the data A. However, the WebGL rendering may be used only when a mobile browser of the device 14 supports WebGL.

The apparatus 100 according to the present embodiment may determine a method of rendering data based on a preset group. For example, a user may apply methods of rendering data to groups that are classified based on a size of the attribute information of the data. CSS rendering may be used to render data of which attribute information has a small size. The apparatus 100 that renders the data of the application according to another embodiment of the present disclosure may determine the method of rendering the data based on performance information of a device. For example, if the same rendering method is used in a smart TV and a computer, a rendering result may vary according to a performance of the device. In detail, if a first rendering method is used in the computer, the data of the application 12 may be rendered at a rate of 60 frames per seconds (FPS). Although the first rendering method is used in the smart TV, it may be difficult to perform rendering at the same speed as in the computer due to a performance difference with the computer. According to an embodiment of the present disclosure, a method of rendering data of an application may be determined in consideration of attribute information of the data and a performance of the smart TV to address a performance problem if the application is executed in the smart TV.

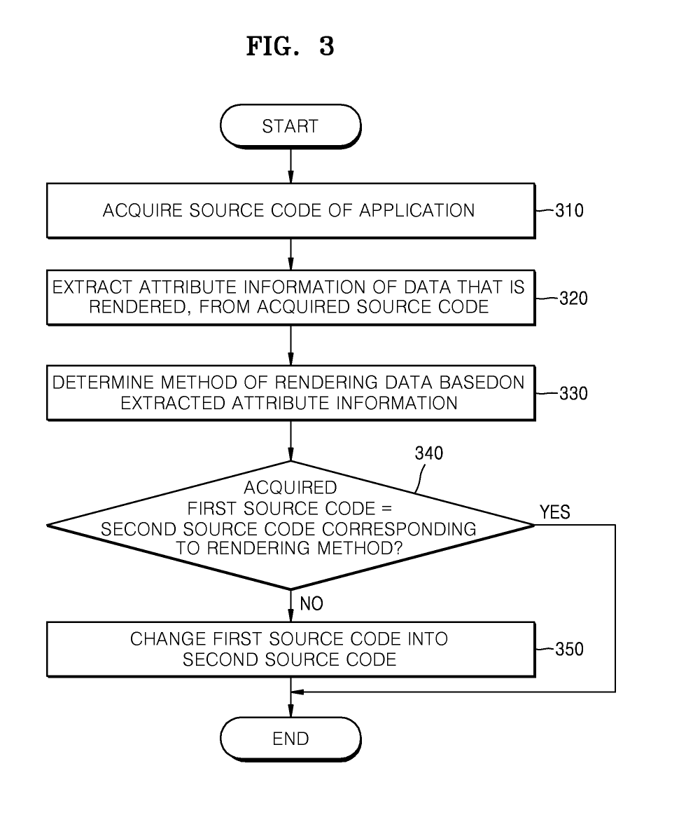

FIG. 3 is a flowchart illustrating a method of changing the source code of the application 12 according to an embodiment of the present disclosure.

In operation 310, the apparatus 100 that renders data of an application acquires the source code of the application 12.

The apparatus 100 according to the present embodiment may acquire the source code of the application 12 from an external device. According to another embodiment, the apparatus 100 may acquire the source code from an application package that is stored in the apparatus 100 and acquired from the external device.

In operation 320, the apparatus 100 extracts attribute information of data displayed on an execution screen of the application 12 from the acquired source code.

In operation 330, the apparatus 100 determines a method of rendering the data based on the extracted attribute information. The apparatus 100 may determine a rendering method for optimally maintaining a performance of the application 12 when executing the application 12, based on the extracted attribute information. According to an embodiment of the present disclosure, the apparatus 100 may determine the method of rendering the data based on a size of the extracted attribute information. According to another embodiment, the apparatus 100 may determine the method of rendering the data based on the size of the extracted attribute information and a performance of a device.

In operation 340, the apparatus 100 determines whether an acquired first source code matches with a second source code corresponding to the determined rendering method. Here, the second source code corresponding to the determined rendering method may be a source code that may be executed by the determined rendering method. In other words, the second source code may be a source code that is grammatically written according to the determined rendering method. For example, if the determined rendering method is a WebGL rendering method, a source code that is grammatically written according to the WebGL rendering method may be a second source code corresponding to the WebGL rendering method.

In operation 350, the apparatus 100 changes the first source code into the second source code. The apparatus 100 according to the present embodiment may change the first source code, in which the application 12 is written, into the second source code corresponding to the rendering method determined in operation 330 so as to use an optimized rendering method for executing the application 12.

The apparatus 100 may store information about a grammar structure, a function, a variable, etc. of a used source code according to respective rendering methods. The apparatus 100 may also store information about relations between the respective rendering methods and the source code to change the source code.

For example, a command to call a coordinate value of an object included in data may be X in a WebGL rendering method, and a command to call the coordinate value of the object included in the data may be Y in a CSS rendering method. If a source code corresponding to the WebGL rendering method is changed into a source code corresponding to the CSS rendering method, the apparatus 100 may read information about a source code relation to change the command X for calling the coordinate value of the object into the command Y.

Variables of the command X to call the coordinate value of the object may be 3 in the WebGL rendering method, and variables of the command Y to call the coordinate value of the object may be 2 in the CSS rendering method. In this case, the apparatus 100 may change the source code by using information about relations between variables respectively input for commands stored according to rendering methods.

Even if a source code that is written when a developer develops the application 12 is not a source code corresponding to a rendering method optimized when executing the application 12, the apparatus 100 according to the present embodiment may flexibly change the source code. For example, the source code is written to apply the CSS rendering method when the developer develops the application 12, but the WebGL rendering method may be determined as the most appropriate rendering method based on attribute information of data. In this case, the apparatus 100 according to the present embodiment may change the source code of the application 12 from a source code corresponding to the CSS rendering method into a source code corresponding to the WebGL rendering method.

The apparatus 100 may also change at least one template for using the determined rendering method. Here, the template may be a function block into which a series of functions are structured to process data-related information according to each rendering method.

If the first source code matches with the second source code, the apparatus 100 may not change the source code and perform rendering by using the rendering method corresponding to the source code in which the application 12 is written.

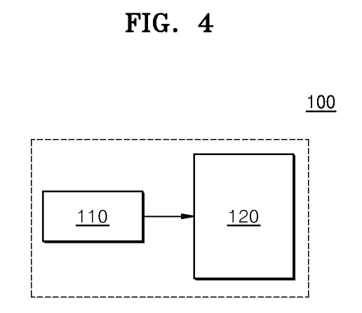

FIG. 4 is a block diagram illustrating an apparatus 100 that renders data of an application according to an embodiment of the present disclosure.

The apparatus 100 of FIG. 4 includes elements related to the present embodiment. Therefore, the apparatus 100 may further include other types of general-purpose elements besides the elements of FIG. 4.

Referring to FIG. 4, the apparatus 100 includes an input/output (I/O) unit 110 and a controller 120.

The I/O unit 110 may acquire a source code of the application 12. The I/O unit 110 according to the present embodiment may acquire the source code of the application 12 from an external device.

According to another embodiment, the apparatus 100 may acquire an application package from the external device. Here, the application package may be data into which the source code of the application 12, a file for executing the application 12, etc. are compressed.

The controller 120 may extract attribute information of data, which is rendered, from the acquired source code. The controller 120 may determine a method of rendering the data based on the extracted attribute information. Here, the attribute information of the data may include at least one of all types of attributes that may be processed by a GPU, i.e., at least one of a shape, a shadow, a color, a position, a material, a size, etc. of an object included in the data.

The controller 120 according to the present embodiment may determine a rendering method for optimally maintaining a performance of the application 12 when executing the application 12, based on the extracted attribute information. For example, the controller 120 may determine the method of rendering the data based on a size of the extracted attribute information. According to another embodiment, the controller 120 may determine the method of rendering the data based on the size of the extracted attribute information and a performance of a device.

The controller 120 may change the source code of the application 12 based on the determined rendering method. The controller 120 according to the present embodiment may determine whether an acquired first source code matches with a second source code corresponding to the determined rendering method. Here, the second source code corresponding to the determined rendering method may be a source code that may be executed by the determined rendering method. In other words, the second source code may be a source code that is grammatically written according to the determined rendering method.

If the first source code does not match with the second source code, the controller 120 may change the first source code into the second source code. The controller 120 according to the present embodiment may change the first source code into the second source code corresponding to the determined rendering method to perform rendering in order to use an optimized rendering method for executing the application 12.

The controller 120 may also change at least one template for using the determined rendering method. Here, the template may be a function block into which a series of functions are structured to process data-related information according to each rendering method.

If the first source code matches with the second source code, the controller 120 may not change the source code and perform rendering by using a rendering method corresponding to the first source code in which the application 12 is written.

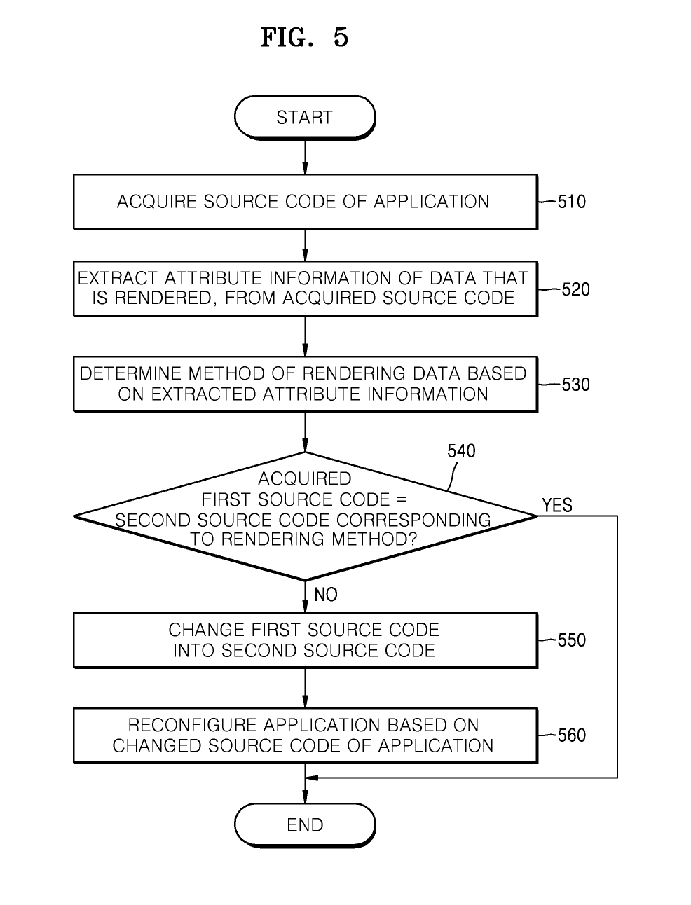

FIG. 5 is a flowchart illustrating a method of reconfiguring the application 12 based on a changed source code of the application 12 by using the apparatus 100 that renders data of the application 12 according to an embodiment of the present disclosure.

In operation 510, the apparatus 100 that renders the data of the application 12 acquires a source code of the application 12.

In operation 520, the apparatus 100 extracts attribute information of data displayed on an execution screen of the application 12 from the acquired source code. Here, the attribute information of the data may include at least one of all types of attributes that may be processed by a GPU, i.e., at least one of a shape, a shadow, a color, a position, a material, a size, etc. of an object included in the data.

In operation 530, the apparatus 100 determines a method of rendering the data based on the extracted attribute information. The apparatus 100 may determine a rendering method for optimally maintaining a performance of the application 12 when executing the application 12, based on the extracted attribute information.

In operation 540, the apparatus 100 determines whether an acquired first source code matches with a second source code corresponding to the determined rendering method. Here, the second source code corresponding to the determined rendering method may be a source code that may be executed by the determined rendering method. In other words, the second source code may be a source code that is grammatically written according to the determined rendering method.

In operation 550, the apparatus 100 changes the first source code into the second source code. If the first source code does not match with the second source code, the apparatus 100 according to the present embodiment may change the first source code into the second source code. The apparatus 100 may also change at least one template for using the determined rendering method.

In operation 560, the apparatus 100 reconfigures the application 12 based on the changed second source code. According to an embodiment of the present disclosure, the device 14 may render data based on the determined rendering method when executing the reconfigured application 12 to optimize the performance of the application 12.

If the first source code matches with the second source code, the apparatus 100 may not change the source code and perform rendering by using a rendering method corresponding to a source code in which an existing application is written.

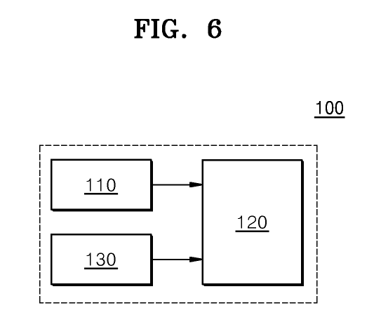

FIG. 6 is a block diagram illustrating an apparatus 100 that renders data of an application according to another embodiment of the present disclosure.

The apparatus 100 of FIG. 6 includes elements related to the present embodiment. Therefore, the apparatus 100 may further include other types of general-purpose elements besides the elements of FIG. 6.

Referring to FIG. 6, the apparatus 100 includes an I/O unit 110, a controller 120, and a packaging unit 130.

The I/O unit 110 and the controller 120 of FIG. 6 may respectively correspond to the I/O unit 110 and the controller 120 of FIG. 4.

The packaging unit 130 may reconfigure the application 12 based on a changed second source code. The device 14 according to an embodiment of the present disclosure may render data based on a determined rendering method when executing the application 12 to optimize a performance of the application 12.

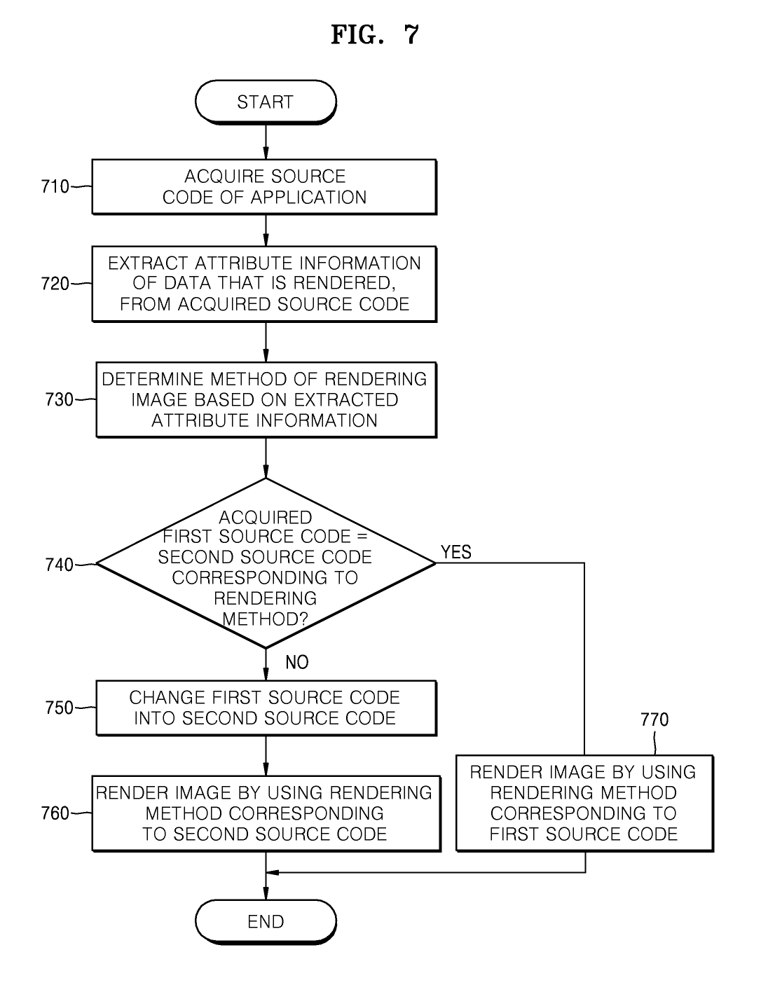

FIG. 7 is a flowchart illustrating a method of rendering data based on a source code of a changed source code of an application by using the apparatus 100 renders data of the application according to an embodiment of the present disclosure.

Operations 710 through 750 may respectively correspond to operations 610 through 650 of FIG. 6.

In operation 760, the apparatus 100 renders data by using a rendering method corresponding to a second source code.

In operation 770, the apparatus 100 renders the data by using a rendering method corresponding to a first source code.

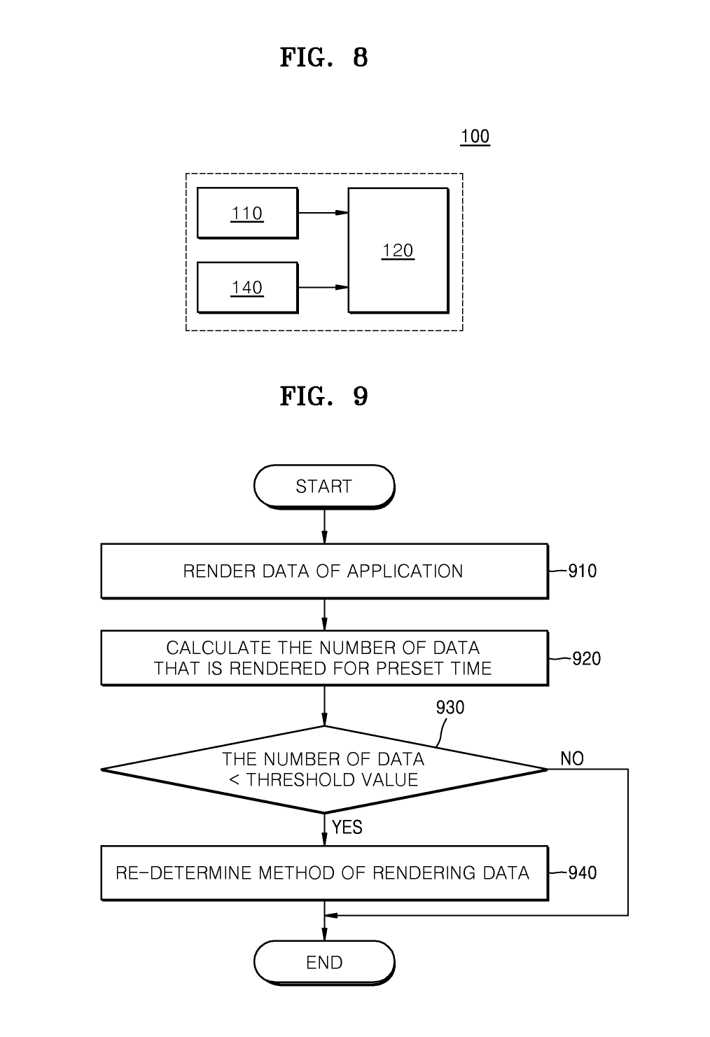

FIG. 8 is a block diagram illustrating an apparatus 100 that renders data of an application according to another embodiment of the present disclosure.

The apparatus 100 of FIG. 8 includes elements related to the present embodiment. Therefore, the apparatus 100 may further include other types of general-purpose elements besides the elements of FIG. 8.

Referring to FIG. 8, the apparatus 100 includes an I/O unit 110, a controller 120, and a renderer 140.

The I/O unit 110 and the controller 120 of FIG. 8 may respectively correspond to the I/O unit 110 and the controller 120 of FIG. 4.

If the controller 120 changes a first source code into a second source code, the renderer 140 may render data by using a rendering method corresponding to the second source code.

If the first source code matches with the second source code and thus is not changed, the renderer 140 may render the data by using a rendering method corresponding to the first source code.

FIG. 9 is a flowchart illustrating a method of re-determining a method of rendering data when executing an application by using the apparatus 100 that renders data according to an embodiment of the present disclosure.

In operation 910, the apparatus 100 renders data based on a determined rendering method. If a rendering method corresponding to a source code written when developing the application is an optimized rendering method according to a determination result, The apparatus 100 according to the present embodiment may perform rendering by using the rendering method corresponding to the source code written when developing the application, based on attribute information of the data.

If it is determined that a rendering method optimized for the application is different from the rendering method corresponding to the source code written when developing the application, the apparatus 100 may change the rendering method to render the data.

In operation 920, the apparatus 100 calculates the number of data that is rendered for a preset time. Here, the number of data may be calculated according to a preset unit. For example, the number of data that is rendered in frame unit such as 60 frames for 1 second may be calculated.

In operation 930, the apparatus 100 determines whether the calculated number of data is lower than a threshold value.

If it is determined in operation 930 that the calculated number of data is lower than the threshold value, the apparatus 100 re-determines a method of rendering the data in operation 940.

The apparatus 100 according to the present embodiment may determine whether the re-determined method of rendering the data is executable. If it is determined that the re-determined method is executable, the apparatus 100 may change a current source code into a source code corresponding to the re-determined method to render the data by the re-determined method. The apparatus 100 may also render the data based on the changed source code.

The apparatus 100 according to the present embodiment may calculate the number of data, which is rendered for the present time, in each preset cycle. Even after the rendering method is changed, the apparatus 100 may calculate the number of data that is rendered for the preset time and, if the calculated number of data is lower than the threshold value, continuously re-determine the method of rendering the data.

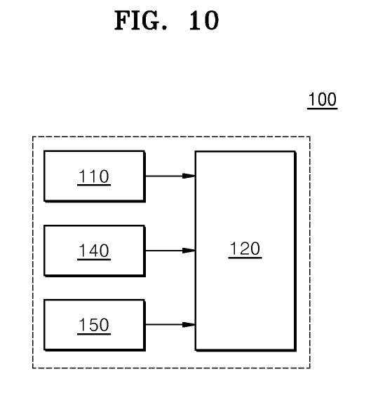

FIG. 10 is a block diagram illustrating an apparatus 100 that renders data of an application according to an embodiment of the present disclosure.

The apparatus 100 of FIG. 10 includes elements related to the present embodiment. Therefore, the apparatus 100 may further include other types of general-purpose elements besides the elements of FIG. 10.

Referring to FIG. 10, the apparatus 100 includes an I/O unit 110, a controller 12, a renderer 140, and a calculator 150.

The I/O unit 110 and the controller 120 of FIG. 10 may respectively correspond to the I/O unit 110 and the controller 120 of FIG. 4.

The I/O unit 110 may acquire a source code of an application. The I/O unit according to the present embodiment may acquire the source code of the application 12 from an external device. According to another embodiment, the apparatus 100 may acquire an application package from the external device.

The controller 120 may extract attribute information of data displayed on an execution screen of the application from the acquired source code. The controller 120 may also determine a method of rendering data based on the extracted attribute information. Here, the attribute information of the data may include at least one of all types of attributes that may be processed by a GPU, i.e., at least one of a shape, a shadow, a color, a position, a material, a size, etc. of an object included in the data.

The controller 120 may also determine a rendering method for optimally maintaining a performance of the application when executing the application, based on the extracted attribute information. For example, the controller 120 may determine the method of rendering the data based on a size of the extracted attribute information. According to another embodiment, the controller 120 may determine the method of rendering the data based on the size of the extracted attribute information and a performance of a device.

The controller 120 may change the source code of the application based on the determined rendering method. If a first source code does not match with a second source code, the controller 120 may change the first source code into the second source code.

The controller 120 may also change at least one template for using the determined rendering method. Here, the template may be a function block into which a series of functions are structured to process data-related information according to each rendering method.

If the first source code matches with the second source code, the controller 120 may not change the source code and perform rendering by using a rendering method corresponding to a source code in which an existing application is written.

If the controller 120 changes the first source code into the second source code, the renderer 140 may render the data by using a rendering method corresponding to the second source code.

If the first source code matches with the second source code and thus is not changed, the renderer 140 may render the data by using a rendering method corresponding to the first source code.

The calculator 150 may calculate the number of data that is rendered for a preset time. For example, the calculator 150 may calculate the number of data that is rendered in frame unit.

The calculator 150 may also determine whether the calculated number of data is lower than a threshold value. If the calculated number of data is lower than the threshold value, the calculator 150 may re-determine the method of rendering the data.

The controller 120 according to the present embodiment may determine whether the method of rendering the data re-determined by the calculator 150 is executable. If it is determined that the method is executable, the controller 120 may change a current source code into a source code corresponding to the re-determined rendering method to render the data. The controller 120 may also control the renderer 140 to render the data based on the changed source code.

The calculator 150 according to the present embodiment may calculate the number of data, which is rendered for the preset time, in each preset cycle.

The calculator 150 may calculate the number of data that is rendered for the preset time after the rendering method is changed and, if the calculated number of data is lower than the threshold value, continuously re-determine the method of rendering the data.

An apparatus according to the present disclosure may include a processor, a memory that stores and executes program data, a permanent storage such as a disk drive, a communication port that communicates with an external apparatus, a user interface such as a touch panel, a key, a button, or the like, etc. Methods of embodying a software module or an algorithm may be stored as computer-readable codes or program commands executable on the processor, on a non-transitory computer-readable recording medium. Examples of the non-transitory computer-readable recording medium include a magnetic storage medium (for example, read-only memory (ROM), random-access memory (RAM), a floppy disc, a hard disk, etc.) and an optical reading medium (for example, compact disc-read-only memories (CD-ROMs), digital versatile discs (DVDs), etc.). The non-transitory computer-readable recording medium may also be distributed over network coupled computer systems so that the computer-readable code is stored and executed in a distributed fashion. The non-transitory computer-readable recording medium may be read by a computer, stored in a memory, and executed by a processor.

All types of documents including published documents, patent applications, patents, etc. cited in the present disclosure may be integrated herein like cited documents are separately and detailed integrated or are entirely integrated herein.

For understanding of the present disclosure, reference numerals are shown in the various embodiments illustrated in the drawings, and particular terminologies are used to describe the various embodiments. However, the present disclosure is not limited by the particular terminologies, and the present disclosure may include all types of elements that may be considered by those of ordinary skill in the art.

The present disclosure may be embodied as functional block structures and various processing operations. These functional blocks may be embodied via various numbers of hardware and/or software structures that execute particular functions. For example, the present disclosure may use direct circuit structures, such as a memory, processing, logic, a look-up table, etc. that may execute various functions through controls of one or more microprocessors or other control apparatuses. Like elements of the present disclosure may be executed as software programming or software elements, the present disclosure may be embodied as a programming or scripting language such as C, C++, assembly language, or the like, including various algorithms that are realized through combinations of data structures, processes, routines, or other programming structures. Functional sides may be embodied as an algorithm that is executed by one or more processors. Also, the present disclosure may use related arts to perform electronic environment setting, signal processing, and/or data processing, etc. Terminology such as a mechanism, an element, a means, or a structure may be widely used and is not limited as mechanical and physical structures. The terminology may also include meanings of a series of routines of software along with a processor, etc.

The particular embodiments described in the present disclosure are just exemplary and do not limit the scope of the present disclosure. For conciseness of the present specification, descriptions of the conventional electronic elements, control systems, software, and other functional sides of the systems have been omitted. Also, connections between lines of elements shown in the drawings or connection members of the lines exemplarily indicate functional connections and/or physical connections or circuit connections. The connections may be replaced or may be indicated as additional various functional connections, physical connections, or circuit connections in a real apparatus. If there is no detailed mention such as “necessary”, “important”, or the like, the connections may not be elements for making the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of rendering data of an application, the method comprising:
acquiring a source code of the application;
extracting attribute information of data displayed on an execution screen of the application from the acquired source code; and
determining a method of rendering the data based on the extracted attribute information.

2. The method of claim 1, wherein the determining of the method of rendering the data based on the extracted attribute information comprises:
changing the source code of the application based on the determined method.

3. The method of claim 2, wherein the changing of the source code of the application comprises:
if an acquired first source code does not match with a second source code corresponding to the determined method, changing the first source code into the second source code.

4. The method of claim 2, further comprising:
reconfiguring the application based on the changed source code.

5. The method of claim 2, further comprising:
selecting a rendering method corresponding to the changed source code; and
rendering the data by using the selected rendering method.

6. The method of claim 5, further comprising:
calculating the number of data that is rendered for a preset time; and
re-determining the method of rendering the data based on the calculated number of data.

7. The method of claim 6, wherein if the calculated number of data is lower than a threshold value, the method of rendering the data is re-determined.

8. The method of claim 1, wherein the extracting of the attribute information of the data comprises:
parsing the acquired source code; and
extracting the attribute information of the data from the parsed source code.

9. The method of claim 1, wherein the attribute information of the data comprises at least one of information about a shape, a shadow, a color, a position, a material, and a size of an object included in the data.

10. The method of claim 1, wherein the method of rendering the data comprises one of web graphic library (WebGL) rendering, cascading style sheet (CSS) rendering, and canvas rendering.

11. A non-transitory computer-readable recording medium having recorded thereon a program for executing in a computer the method of claim 1.

12. An apparatus for rendering data of an application, the apparatus comprising:
an input/output (I/O) unit which acquires a source code of the application; and
a controller which extracts attribute information of data displayed on an execution screen of the application from the acquired source code and determines a method of rendering the data based on the extracted attribute information.

13. The apparatus of claim 12, wherein the controller changes the source code of the application based on the determined method.

14. The apparatus of claim 13, wherein if an acquired first source code does not match with a second source code corresponding to the determined method, the controller changes the first source code into the second source code.

15. The apparatus of claim 13, further comprising:
a packaging unit which reconfigures the application based on the changed source code.

16. The apparatus of claim 13, further comprising:
a renderer which renders the data by using a rendering method that is selected by the controller based on the changed source code.

17. The apparatus of claim 16, further comprising:
a calculator which calculates the number of data that is rendered for a preset time,
wherein the controller re-determines the method of rendering the data based on the calculated number of data.

18. The apparatus of claim 17, wherein if the calculated number of data is lower than a threshold value, the controller re-determines the method of rendering the data.

19. The apparatus of claim 12, wherein the controller parses the acquired source code and extracts the attribute information of the data from the parsed source code.

20. The apparatus of claim 12, wherein the attribute information of the data comprises at least one of information about a shape, a shadow, a color, a position, a material, and a size of an object included in the data.

21. The apparatus of claim 12, wherein the method of rendering the data comprises one of web graphic library (WebGL) rendering, cascading style sheet (CSS) rendering, and canvas rendering.
